(19) United States
(12) Patent Application Publication
(10) Pub. No.: US 2026/0105818 A1
(43) Pub. Date: Apr. 16, 2026

(54) MONITORING SYSTEM FOR PORTABLE ARTICLES WITH ELECTRONIC KEY ARMING

(71) Applicant: SE-KURE CONTROLS, INC., Franklin Park, IL (US)

(72) Inventor: David M. Adams, Stone Park, IL (US)

(21) Appl. No.: 19/356,297

(22) Filed: Oct. 13, 2025

Related U.S. Application Data
(60) Provisional application No. 63/706,940, filed on Oct. 14, 2024.

(51) Int. Cl. G08B 13/14

(52) U.S. Cl. CPC G08B 13/1436

(57) ABSTRACT

A system disclosed herein comprises a monitoring system for monitoring system breaches and having an armed state and an unarmed state. The monitoring system is operatively connected to a portable article to detect select movement of the portable article relative to the monitoring system, wherein in the armed state a system breach is detected responsive to the detected select movement of the portable article, and in the unarmed state no breach is detected responsive to the detected select movement of the portable article. A signal generator is operatively connected to the monitoring system to generate a detectable signal as an incident of a system breach. A programmable actuator system is operatively connected to the monitoring system and is operable to enable reprogramming of the system and to change the monitoring system between the armed state and the unarmed state, and comprises an input port for receiving an electronic key. In response to an input generated by an authorized electronic key detected by the actuator system, the actuator system is enabled to selectively reprogram the system or to change the monitoring system from the armed state into the unarmed state or to change the monitoring system from the unarmed state into the armed state.

### CROSS-REFERENCE TO RELATED APPLICATIONS

This is a non-provisional application claiming priority to U.S. Provisional Application No. 63/706,940 filed Oct. 14, 2024.

### BACKGROUND OF THE INVENTION

### Field of the Invention

This invention relates to portable consumer articles and, more particularly, to a monitoring system for the articles that generates a signal as an incident of a system breach and uses an electronic key for arming and disarming.1

### Background Art

A multitude of monitoring/security systems have been devised to limit unauthorized handling and theft of portable articles. The theft problem is particularly prevalent in consumer electronics stores where expensive consumer articles such as cell phones, and the like, are displayed in large numbers and handled by many shoppers contemplating purchase.

The monitoring systems that have been devised vary widely in terms of construction, how they operate, and the particular breaches that they are designed to detect.

Typically, regardless of the precise construction of the monitoring system, it is configured to have an armed state and an unarmed state. In the unarmed state, the system can be set up to monitor one or more articles, as at a particular display location. Once the desired articles have been integrated into the monitoring system, the system can be placed in the armed state, as a result of which the designed-for system breach will cause generation of a signal that is detectable by itself and/or sent to another device or location for processing. By disarming a system, previously monitored articles may be handled and moved about without restriction. A disarmed system might be changed by being connected to another article, reconfigured, reprogramed, etc.

Various actuators have been devised to facilitate the changing of the state of such systems by only authorized personnel. Currently, systems use keys, RFID, I-buttons, keypads, etc. Most of these systems require a user to carry or obtain a separate, commonly dedicated, device to be used when the system is armed and/or disarmed.

Keypads that are operable without an external device are prone to being compromised by creative thieves who may independently obtain copies of keys, access codes and/or observe the input thereof by an authorized person.

Given the number of such monitoring systems that may be present in a particular retail establishment, it is important for efficiency that only authorized personnel be able to readily arm and disarm the systems as to permit articles to be moved between displays and allow reconfiguration of such systems, without compromising overall security.

One option is to have a number of different arming/disarming devices with each being operable with security systems associated with only one displayed device, or a limited number of displayed devices. In a large retail operation, this could require dozens of such arming/disarming devices to be kept on hand in a manner that their use can be coordinated with their related security systems. This may be highly inconvenient and may create situations where such devices are not readily available when needed.

Alternatively, a “master” device may be usable to operate large numbers, or all, of the monitoring systems in a display area. If the master device is controlled by an unauthorized person, the security of large numbers of devices may be compromised, thereby requiring re-keying, reprogramming, or other system modifications to safeguard the devices.

1

### SUMMARY OF THE INVENTION

In one form, the invention is directed to the combination of a portable article and a system for monitoring the portable article. The monitoring system has an armed state and an unarmed state. The monitoring system in the armed state is configured to generate a signal as an incident of a system breach. The monitoring system includes an actuator system that is operable to change the monitoring system between the armed state and the unarmed state. The monitoring system is changeable at least one of: a) from the armed state into the unarmed state; and b) from the unarmed state into the armed state in response to insertion of an electronic key into the monitoring system.

In one aspect, the system comprises a monitoring system for monitoring system breaches and having an armed state and an unarmed state. The monitoring system is operatively connected to a portable article to detect select movement of the portable article relative to the monitoring system, wherein in the armed state a system breach is detected responsive to the detected select movement of the portable article, and in the unarmed state no breach is detected responsive to the detected select movement of the portable article. A signal generator is operatively connected to the monitoring system to generate a detectable signal as an incident of a system breach. A programmable actuator system is operatively connected to the monitoring system and is operable to enable reprogramming of the system and to change the monitoring system between the armed state and the unarmed state, and comprises an electronic key. In response to an authorized electronic key detected by the monitoring system the actuator system is enabled to selectively reprogram the system or to change the monitoring system from the armed state into the unarmed state or to change the monitoring system from the unarmed state into the armed state.

In one form, the monitoring system is changed from one of the armed state and unarmed state into the other of the armed state and the unarmed state as an incident of the input being generated.

In one form, as an incident of the input being generated, the actuator system is operable to change the monitoring system from one of the armed and unarmed states into the other of the armed and unarmed states.

In one form, the electronic key comprises a programable memory circuit.

In one form, the electronic key comprises a memory circuit including a unique serial number.

In one form, the electronic key comprises a memory circuit including a unique serial number having at least 32 bits.

In one form, the system breach that causes the generation of the detectable signal is movement of the portable article in relationship to a support for the portable article.

In one form, the system breach that causes the generation of the detectable signal is a change in orientation of the portable article.

In one form, the system breach that causes the generation of the detectable signal is a movement of the portable article outside of a prescribed area.

In one form, the system breach that causes the generation of the detectable signal is a separation of a part of the monitoring system from the portable article.

In one form, the system breach that causes the generation of the detectable signal is a reconfiguration of a part of the monitoring system.

In one form, the monitoring system includes a signal generator on the portable article and a signal receiver. The system breach results from the signal generator and signal receiver either: a) establishing communication; or b) having a communication interrupted.

In one form, the monitoring system includes a signal receiver on the portable article and a signal generator. The signal breach results from the signal generator and signal receiver either: a) establishing communication; or b) having a communication interrupted.

In one form, the system breach that causes the generation of the detectable signal is movement of the portable article.

In one form, the generated signal is communicated to a receiver.

In one form, the receiver generates a separate signal that can be identified by a user.

In one form, the generated signal is an audible signal.

In one form, the generated signal is a visual signal.

In one form, the portable article is a portable electronic article.

In one form, the portable article is a portable smart device displayed on a stand with the monitoring system in the armed state.

In one form, the electronic key comprises a housing surrounding a USB connector wherein the housing precludes insertion of the electronic key in a conventional computer USB port.

### BRIEF DESCRIPTION OF THE DRAWINGS

FIG. 1 is a block diagram representation of the combination of a portable article and a system for monitoring the portable article, according to the invention;

FIG. 2 is a block diagram representation as in FIG. 1 and showing a modified form of monitoring system;

FIG. 3 is a block diagram representation of a connection between the inventive monitoring system and a portable article;

FIG. 4 is a block diagram representation showing one specific form of connection as shown generically in FIG. 3;

FIG. 5 is a block diagram representation showing another specific type of connection as shown generically in FIG. 3;

FIG. 6 is a block diagram representation of the electronic key of FIG. 1;

FIG. 7 is a perspective view of an exemplary electronic key for use with the monitoring system of FIG. 1; and

FIG. 8 is a perspective view of an integrated charger and alarm unit used with the electronic key in accordance with the invention.

### DETAILED DESCRIPTION OF THE PREFERRED EMBODIMENT

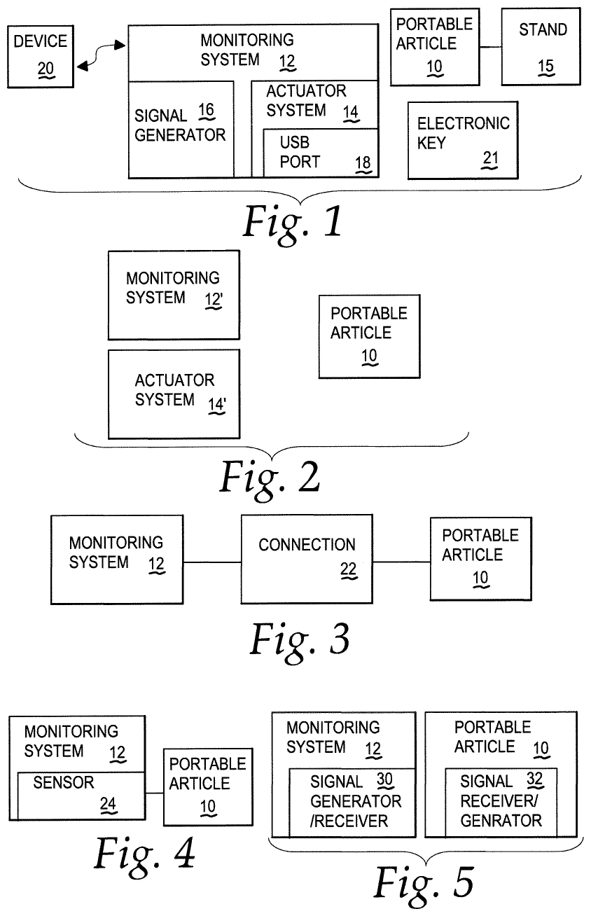

In FIG. 1, one form of the invention is depicted in block diagram form, consisting of a portable article 10 and a monitoring system 12, with an actuator system 14, for the portable article 10.

The portable article 10 may be any type of article, typically of the type displayed in retail establishments for inspection or purchase on site. The article may range from an article of clothing to an expensive or complicated electronic article. As one example, the portable article 10 may be a mobile smart device, with a display having an input surface, that is mounted/displayed on a stand 15.

The monitoring system 12 has an armed state and an unarmed state. The monitoring system 12 has a signal generator 16. The monitoring system 12 is configured so that the signal generator 16 generates a signal as an incident of a system breach.

The actuator system 14 has an input port 18, which in the illustrated embodiment of the invention comprises a USB Type A connector port. The USB port 18 accepts an electronic key 21. Upon detecting an authorized electronic key 21, an input is generated whereupon the actuator system 14 is operable to change, or allow change of, at least one of: a) the monitoring system 12 from the armed state into the unarmed state; and b) the monitoring system 12 from the unarmed state into the armed state.

Upon detecting the authorized electronic key 21, the actuator system 14 may automatically cause the monitoring system 12 to change from the armed/unarmed state into the unarmed/armed state.

Alternatively, upon detecting the authorized electronic key 21, the actuator system 14 may be changed into a mode wherein it is capable of being operated, as by further inputs, to change the state of the monitoring system 12 and/or to make other system changes, such as, for example, authorizing additional electronic keys.

In FIG. 2, a modified form of monitoring system is shown at 12′ wherein the actuator system 14′ is a separate subsystem. The systems 12′, 14′ otherwise function as the corresponding systems in FIG. 1 to monitor the portable article 10.

The signal generator 16 may itself be capable of producing a signal that is detectable, as by sight and/or sound. Alternatively, the signal generator may generate an input to a separate device 20, as at a remote location, where it can be viewed and/or otherwise processed. For example, the signal may be sent to a monitoring location, as to a computer or cell phone, from which information may be gathered and/or other action might be initiated. For example, details regarding the breach might be obtained, such as identification of an article and/or its location. Follow-up procedures might be initiated to track the subject article, notify others of the breach, etc.

As shown in FIG. 3, there is some connection 22 between the monitoring system 12 and portable article 10. This generic showing is intended to encompass a connection that is part of the monitoring system 12 and/or portable article 10 and/or partially or entirely independent thereof. For example, the connection 22 may be a mechanical connection such as a tether or an electrical connection that may be wired or wireless.

The connection 22 may be between the monitoring system 12 and some part of the portable article 10 that already exists. Alternatively, as shown in FIG. 4, a sensor 24 of the monitoring system 12 might be integrated into, or attached to, the portable article 10. The sensor 24 might detect movement of the portable article 10 at or in relationship to a support therefor. The sensor 24 might detect an abrupt movement of the portable article 10. The sensor 24 might sense a change in orientation of the portable article 10. In any of these instances, the movement constitutes the system breach that causes the generation of the signal by the generator 16.

The system breach may result from movement of the portable article outside of a prescribed area which breaks or establishes a connection between the monitoring system 12 and the portable article 10 to cause the signal generation.

For example, as shown in FIG. 5, the monitoring system 12 may have a signal generator/receiver 30 with the portable article having a cooperating signal receiver/generator 32. The system may be configured so that there is a communication of signals between the monitoring system 12 and portable article 10 that is interrupted when the system is breached. For example, the signal may be interrupted when the monitoring system 12 and portable article 10 are separated beyond a predetermined distance.

Alternatively, the interruption may occur because of a system reconfiguration. For example, the sensor 24 and the portable article 10 may be separated in an unauthorized fashion whereby the communication is interrupted. This may occur as the sensor 24 is removed from the portable article 10, if there is a severance of an electrical communication line between the monitoring system 12 and portable article 10, etc.

In an alternative design, a signal receiver/generator 30 at an exit location senses the presence of the signal receiver/generator 32 and causes a breach signal to be generated.

Essentially, the generic showing of components in FIGS. 1-5 is intended to encompass virtually every type of portable article monitoring system that exists, and that might be devised, and that has different states—armed and unarmed—between which the monitoring system 12 is changed in normal operation, as to facilitate setup and changing of monitoring configurations.

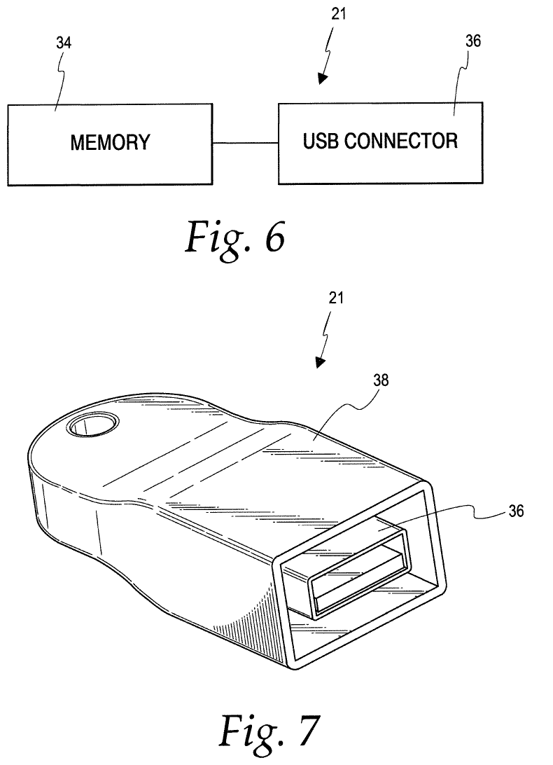

Circuitry for the electronic key 21 is illustrated in block diagram form in FIG. 6 and comprises a memory 34 operatively connected to a USB connector 36, which in the illustrated embodiment of the invention comprises a USB Type A connector, compatible with the input port 18, see FIG. 1. As is apparent, the invention is not limited to USB Type A connections. Other types of USB connectors, or any other generic or proprietary connectors could be used as will be apparent to those skilled in the art.

In the illustrated embodiment of the invention the memory 34 comprises a serial EEPROM preprogrammed with a unique 32 bit serial number. Advantageously, the serial number is scalable to 48-bit, 64-bit, 128-bit, 256-bit, and other lengths. At set up the monitoring system must be programmed to identify authorized serial numbers. Thereafter, if an electronic key 21 is inserted in the input port 18, then the monitoring system reads the unique serial number and compares it to the stored list of authorized serial numbers. If an authorized electronic key is detected, then the appropriate change, as discussed above, may be made.

FIG. 7 illustrates an exemplary electronic key 21 comprising a housing 38 enclosing circuitry including the memory 34, see FIG. 6, and the USB connector 36. The USB connector 36 is recessed into the housing 38 to prevent the USB connector 36 from being inserted into a computer, or the like, which require that the USB connector extend outwardly of the housing as in conventional USB drives or memory sticks or the like.

The actuator system 14 might be programmed to recognize one or more electronic keys 21 such that it might be inoperable by other than those authorized. The actuator system 14 might be reprogrammable upon an authorized person inputting his/her electronic key 21.

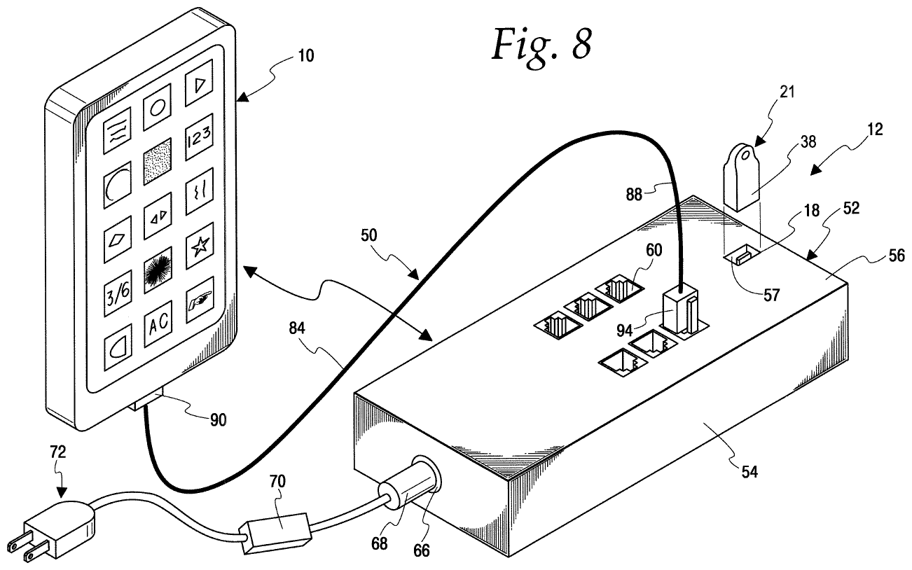

FIG. 8 illustrates an exemplary monitoring system 12 for monitoring a portable article 10 in the form of a mobile phone and using the electronic key 21 for changing system operation, as discussed above. As is apparent, this is a single example of use of the invention and does not limit the principles of the invention.

A sensor 50 is shown for use at a point of purchase display for a chargeable portable electronic device 10 and connected to the monitoring system 12, which comprises an alarm unit. The portable article 10 may be of any design and includes a rechargeable battery.

The monitoring system 12 comprises a housing 52 of parallelepiped construction including a base 54 and a removable cover 56. The cover 56 includes the input port 18 for receiving the electronic key 21. Particularly, the input port USB connector 18 is inset behind an enlarged opening 57. The opening 57 is sized to receive the key housing 38. The key housing 38 and the opening 57 are larger than a conventional USB port terminal opening that is used in personal computers and the like. This precludes the electronic key 21 from being inadvertently inserted in a personal computer USB port.

The illustrated housing 52 supports six alarm receptacles 60. Each alarm receptacle 60 comprises a conventional modular receptacle. As will be apparent, other types of receptacles can be used depending on connectors used on the sensor 50.

A power receptacle 66 in the housing is adapted to receive a barrel jack connector 68. The connector 68 receives DC power from an AC/DC adaptor 70 which is in turn connected to a plug 72 for connection to an AC electrical power source.

The sensor 50 comprises a cable 88 connected to a sensing device 90 operatively attached to the portable article 10. The sensing device 90 may take any known form. The cable 88 terminates in a conventional modular plug 94. The modular plug 94 is receivable in the modular receptacle 60 for interfacing with the alarm circuitry in the monitoring system 12. Thus, the monitoring system can determine if the sensing device 90 is attached to the portable article 10, as is well known and is not part of the invention.

To change the state of the monitoring system 12 of FIG. 8, the electronic key 21 is inserted in the input port 18. After determining that the key is an authorized electronic key, the actuator system 14 is enabled to selectively reprogram the system 12 or to change the monitoring system 12 from the armed state into the unarmed state or to change the monitoring system from the unarmed state into the armed state. As is apparent, reprogramming the system 12 comprises more than changing state and includes reconfiguring the overall system as well as possible software changes, as necessary or desired.

The present invention has been described with respect to flowcharts and/or block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. Other embodiments may be within the scope of the following claims.

The foregoing disclosure of specific embodiments is intended to be illustrative of the broad concepts comprehended by the invention.

1. A system comprising:
a monitoring system for monitoring system breaches and having an armed state and an unarmed state, the monitoring system being operatively connected to a portable article to detect select movement of the portable article relative to the monitoring system, wherein in the armed state a system breach is detected responsive to the detected select movement of the portable article, and in the unarmed state no breach is detected responsive to the detected select movement of the portable article;
a signal generator operatively connected to the monitoring system to generate a detectable signal as an incident of a system breach;
an electronic key; and
a programmable actuator system operatively connected to the monitoring system and operable to enable reprogramming of the system and to change the monitoring system between the armed state and the unarmed state, and comprising an input port for receiving ab electronic key, and in response to an input generated by an authorized electronic key operatively connected to the input port, the actuator system is enabled to selectively reprogram the system or to change the monitoring system from the armed state into the unarmed state or to change the monitoring system from the unarmed state into the armed state.

2. The system according to claim 1 wherein the monitoring system is changed from one of the armed state and unarmed state into the other of the armed state and the unarmed state as an incident of the input being generated.

3. The system according to claim 1 wherein as an incident of the input being generated, the actuator system is operable to change the monitoring system from one of the armed and unarmed states into the other of the armed and unarmed states.

4. The system according to claim 1 wherein the electronic key comprises a programmable memory circuit.

5. The system according to claim 1 wherein the electronic key comprises a memory circuit including a unique serial number.

6. The system according to claim 1 wherein electronic key comprises a memory circuit including a unique serial number having at least 32 bits.

7. The system according to claim 1 wherein the system breach that causes the generation of the detectable signal is movement of the portable article in relationship to a support for the portable article.

8. The system according to claim 1 wherein the system breach that causes the generation of the detectable signal is a change in orientation of the portable article.

9. The system according to claim 1 wherein the system breach that causes the generation of the detectable signal is a movement of the portable article outside of a prescribed area.

10. The system according to claim 1 wherein the system breach that causes the generation of the detectable signal is a separation of a part of the monitoring system from the portable article.

11. The system according to claim 1 wherein the system breach that causes the generation of the detectable signal further comprises a reconfiguration of a part of the monitoring system.

12. The system according to claim 1 wherein the monitoring system comprises a signal generator on the portable article and a signal receiver and a system breach results from the signal generator and signal receiver either: a) establishing communication; or b) having a communication interrupted.

13. The system according to claim 1 wherein the monitoring system comprises a signal receiver on the portable article and a signal generator, and a signal breach results from the signal generator and signal receiver either: a) establishing communication; or b) having a communication interrupted.

14. The system according to claim 1 wherein the generated signal is communicated to a receiver.

15. The system according to claim 14 wherein the receiver generates a separate signal that can be identified by a user.

16. The system according to claim 1 wherein the generated signal is an audible signal.

17. The system according to claim 1 wherein the generated signal is a visual signal.

18. The system according to claim 1 wherein the portable article is a portable electronic article.

19. The system according to claim 1 wherein the portable article is a portable smart device displayed on a stand with the monitoring system in the armed state.

20. The system according to claim 1 wherein the electronic key comprises a housing surrounding a USB connector wherein the housing precludes insertion of the electronic key in a conventional computer USB port.
